(19) United States
(12) Patent Application Publication
(10) Pub. No.: US 2026/0369889 A1
(43) Pub. Date: Nov. 19, 2026

(54) SPIRAL ANTENNA, RESISTOR CAVITY TERMINATION, MODE-FORMER CIRCUIT, AND RADOME INTEGRATED IN SINGLE STRUCTURE

(71) Applicant: Raytheon Company, Arlington, VA (US)

(72) Inventors: Justin E. Stroup, Anna, TX (US); Joshua T. Ruff, Allen, TX (US)

(21) Appl. No.: 19/212,379

(22) Filed: May 19, 2025

(51) Int. Cl. H01Q 9/27; H01Q 1/40; H01Q 5/378; H01Q 17/00; H01Q 25/02

(52) U.S. Cl. CPC H01Q 9/27; H01Q 1/405; H01Q 5/378; H01Q 17/00; H01Q 25/02

(57) ABSTRACT

A circuit card assembly (CCA) includes a dielectric substrate having a first portion and a second portion that form a stepped cavity. The first portion extends a first depth from a first planar surface defining a first plane to a second plane of the stepped cavity. The second portion extends a second depth from the first planar surface to a third plane of the stepped cavity beyond the second plane. The CCA also includes a plurality of conductive first grounding vias electrically coupled to a first planar grounding conductor that defines the second plane and to a second planar grounding conductor that defines the third plane. The CCA further includes at least one conductive feed via that extends through the stepped cavity. The at least one conductive feed via includes first and second ends configured to electrically couple to first and second devices.

### GOVERNMENT RIGHTS

This invention was made with government support under a contract from the U.S. government. The government may have certain rights in this invention.

### TECHNICAL FIELD

This disclosure relates generally to antenna structures. More specifically, this disclosure relates to a spiral antenna, resistor cavity termination, mode-former circuit, and radome integrated in a single structure.

### BACKGROUND

Traditional spiral antennas with multiple simultaneous beams for direction finding (DF) systems include an antenna, a mode-former circuit, and a radome, which are fabricated independently before being connected together. These traditional spiral antennas are cavity-backed multi-arm spiral antennas that require a large quantity of parts and require assembly of a radome, a spiral antenna printed wiring board (PWB), a feed PWB, a mode-former PWB, a machined housing, and a cavity termination within which absorbers are installed. The quantity of parts and assembly increases cost and complexity. This traditional process of connecting independently-fabricated parts can be complex as well as expensive and can negatively impact performance at higher frequencies that are more sensitive to imperfect connections. In traditional cavity-backed multi-arm spiral antennas, an antenna, a mode-former circuit, and a radome are fabricated independently before being assembled. Typically, the antenna and mode-former are independent printed circuit boards (PCBs) separately inserted into a metal cavity filled with air and a multilayer absorber stack, and a radome is bonded onto the front of the assembly.

### SUMMARY

This disclosure relates to a spiral antenna, resistor cavity termination, mode-former circuit, and radome integrated in a single structure.

In a first embodiment, a circuit card assembly (CCA) includes a dielectric substrate having a first portion and a second portion that form a stepped cavity. The first portion spans a first diameter and extends a first depth from a first planar surface defining a first plane to a second plane of the stepped cavity. The second portion spans a second diameter less than the first diameter and extends a second depth from the first planar surface to a third plane of the stepped cavity beyond the second plane. The CCA also includes a plurality of conductive first grounding vias electrically coupled to a first planar grounding conductor that defines the second plane and to a second planar grounding conductor that defines the third plane and annularly surrounding the second portion. The CCA further includes at least one conductive feed via that extends through the stepped cavity. The at least one conductive feed via includes a first end configured to electrically couple to a first device at the first planar surface and a second end opposite the first end beyond the third plane configured to electrically couple to a second device.

Any single one or any combination of the following features may be used with the first embodiment. The first device may include a spiral antenna, and the second device may include a mode-former circuit configured to form simultaneous beams including a sum beam and a delta beam. The CCA may include a parasitic resistive film embedded within the dielectric substrate between the first plane and the second plane, overlapping the first planar grounding conductor, and annularly surrounding the stepped cavity. The first device may include multiple arms that form a spiral antenna, and the at least one conductive feed via may include multiple conductive feed vias respectively electrically coupled to the multiple arms. The conductive first grounding vias may be embedded within the dielectric substrate and spaced apart from each other by a distance that is about 1/10 of a wavelength at the highest frequency the spiral antenna is configured to emit. The CCA may include multiple planar grounding conductors stacked on an opposite side of the second planar grounding conductor relative to the conductive first grounding vias, and the planar grounding conductors may include a rear planar grounding conductor that includes multiple openings within which the dielectric substrate electrically isolates the rear planar grounding conductor from signal conductors of the second device. The CCA may include a plurality of conductive second grounding vias between the second planar grounding conductor and the rear planar grounding conductor, where (i) at least some of the conductive second grounding vias may be positioned to annularly surround the second device and (ii) different subsets of the conductive second grounding vias may extend between the planar grounding conductor adjacent to each other or adjacent to the second planar grounding conductor to thereby form multiple layers of the second grounding vias.

In a second embodiment, a system includes a dielectric substrate having a first portion and a second portion that form a stepped cavity. The first portion spans a first diameter and extends a first depth from a first planar surface defining a first plane to a second plane of the stepped cavity. The second portion spans a second diameter less than the first diameter and extends a second depth from the first planar surface to a third plane of the stepped cavity beyond the second plane. The system also includes a plurality of conductive first grounding vias electrically coupled to a first planar grounding conductor that defines the second plane and to a second planar grounding conductor that defines the third plane and annularly surrounding the second portion. The system further includes a spiral antenna within the dielectric substrate and at least partially on the first planar surface of the stepped cavity. In addition, the system includes at least one conductive feed via that extends through the stepped cavity. The at least one conductive feed via includes a first end electrically coupled to the spiral antenna at the first planar surface and a second end opposite the first end beyond the third plane configured to electrically couple to a mode-former circuit.

Any single one or any combination of the following features may be used with the second embodiment. The system may include the mode-former circuit, and the mode-former circuit may be configured to form simultaneous beams including a sum beam and a delta beam. The system may include a parasitic resistive film embedded within the dielectric substrate between the first plane and the second plane, overlapping the first planar grounding conductor, and annularly surrounding the stepped cavity. The spiral antenna may include multiple arms, and the at least one conductive feed via may include multiple conductive feed vias respectively electrically coupled to the multiple arms. The conductive first grounding vias may be embedded within the dielectric substrate and spaced apart from each other by a distance that is about 1/10 of a wavelength at the highest frequency the spiral antenna is configured to emit. The distance can be about 1/10 of a wavelength at a highest frequency that the spiral antenna is configured to emit. The system may include multiple planar grounding conductors stacked on an opposite side of the second planar grounding conductor relative to the conductive first grounding vias, and the planar grounding conductors may include a rear planar grounding conductor that includes multiple openings within which the dielectric substrate electrically isolates the rear planar grounding conductor from signal conductors of the mode-former circuit. The system may include a plurality of conductive second grounding vias between the second planar grounding conductor and the rear planar grounding conductor, where (i) at least some of the conductive second grounding vias may be positioned to annularly surround the mode-former circuit and (ii) different subsets of the conductive second grounding vias may extend between the planar grounding conductors adjacent to each other or adjacent to the second planar grounding conductor to thereby form multiple layers of the second grounding vias. The system may include at least two resistor terminations and connectors configured to connect to the mode-former circuit via conductors extending though the openings. The system may include a superstrate radome formed on the spiral antenna and configured to protect the spiral antenna.

In a third embodiment, a method includes providing a dielectric substrate having a first portion and a second portion that form a stepped cavity. The first portion spans a first diameter and extends a first depth from a first planar surface defining a first plane to a second plane of the stepped cavity. The second portion spans a second diameter less than the first diameter and extends a second depth from the first planar surface to a third plane of the stepped cavity beyond the second plane. The method also includes forming a plurality of conductive first grounding vias electrically coupled to a first planar grounding conductor that defines the second plane and to a second planar grounding conductor that defines the third plane and annularly surrounding the second portion. The method further includes forming a spiral antenna within the dielectric substrate and at least partially on the first planar surface of the stepped cavity. In addition, the method includes forming at least one conductive feed via that extends through the stepped cavity. The at least one conductive feed via includes a first end electrically coupled to the spiral antenna at the first planar surface and a second end opposite the first end beyond the third plane configured to electrically couple to a mode-former circuit.

Any single one or any combination of the following features may be used with the third embodiment. The method may include forming multiple planar grounding conductors stacked on an opposite side of the second planar grounding conductor relative to the conductive first grounding vias, and the planar grounding conductors may include a rear planar grounding conductor that includes multiple openings within which the dielectric substrate electrically isolates the rear planar grounding conductor from signal conductors of the mode-former circuit. The method may include forming a plurality of conductive second grounding vias between the second planar grounding conductor and the rear planar grounding conductor, where (i) at least some of the conductive second grounding vias may be positioned to annularly surround the mode-former circuit and (ii) different subsets of the conductive second grounding vias may extend between the planar grounding conductors adjacent to each other or adjacent to the second planar grounding conductor to thereby form multiple layers of the second grounding vias.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIGS. 1A and 1B illustrate an example system in which a spiral antenna, a resistor cavity termination, a mode-former circuit, and a radome are integrated into a single structure according to this disclosure;

FIG. 2 illustrates a cross-sectional view of the example system of FIG. 1 according to this disclosure; and

FIG. 3 illustrates an example method of integrating a spiral antenna with a resistor cavity termination, a mode-former circuit, and a radome into a single structure according to this disclosure.

### DETAILED DESCRIPTION

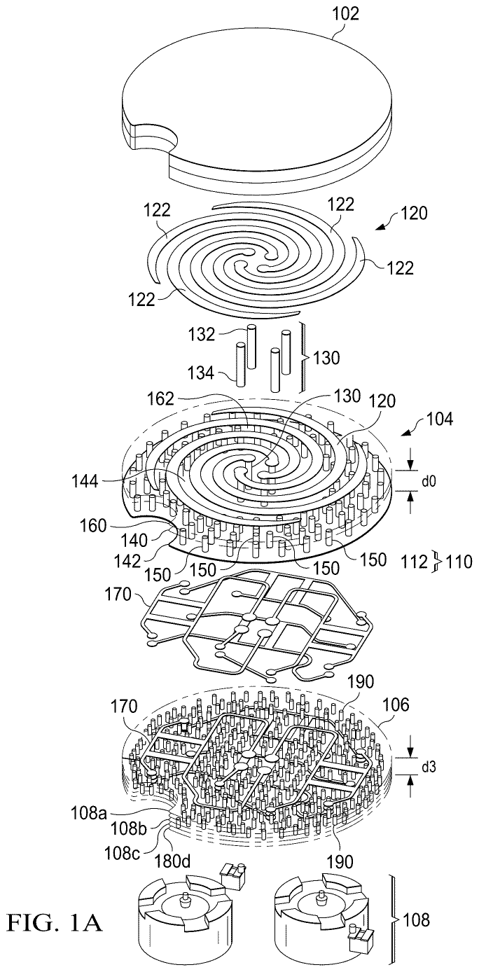

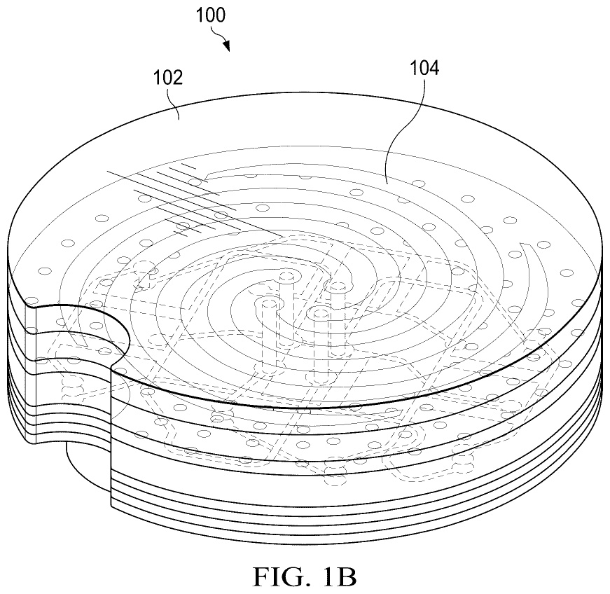

FIGS. 1A through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, traditional cavity-backed multi-arm spiral antennas with multiple simultaneous beams require a large quantity of parts and require assembly of a radome, a spiral antenna printed wiring board (PWB), a feed PWB, a mode-former PWB, a machined housing, and a cavity termination within which absorbers are installed. The quantity of parts and assembly increases cost and complexity. Traditional spiral antenna direction finding (DF) systems include an antenna, a mode-former circuit, and a radome, which are fabricated independently before being connected together. This traditional process of connecting independently-fabricated parts can be complex as well as expensive and can negatively impact performance at higher frequencies that are more sensitive to imperfect connections. In traditional cavity-backed multi-arm spiral antennas, an antenna, a mode-former circuit, and a radome are fabricated independently before being assembled. Typically, the antenna and mode-former are independent printed circuit boards (PCBs) separately inserted into a metal cavity filled with air and a multilayer absorber stack, and a radome is bonded onto the front of the assembly.

This disclosure provides cavity-backed multi-arm spiral antennas that can be integrated into circuit card assemblies (CCAs) or other systems. Embodiments of this disclosure significantly reduce cost and complexity by enabling individual integrated CCAs or other systems to be produced and used. For example, at Ka-band, traditional manufacturing and assembly methods are prohibitive due to part sizes and assembly tolerances. By integrating an antenna, a cavity, a mode-former, and a radome into a single structure, embodiments of this disclosure can reduce material cost by utilizing fewer components, reduce assembly complexity and costs by performing fewer fabrication steps, improve performance (such as by enabling operation with less signal loss compared to traditionally-manufactured and assembled antenna systems), and increase operational frequencies. That is, embodiments of this disclosure can be fabricated at smaller feature sizes using PCB/PWB manufacturing and fewer interconnections, which can enable higher frequency capabilities. Embodiments of this disclosure therefore reduce or eliminate cumbersome build processes, enabling full antenna assemblies to be delivered as integrated products (such as from PCB manufacturers). The antenna assemblies may be used in any suitable applications, such as coarse direction finding (DF) applications that need low-cost and low size, weight, and power (SWaP) solutions.

FIGS. 1A and 1B illustrate an example system 100 in which a spiral antenna, a resistor cavity termination, a mode-former circuit, and a radome are integrated into a single structure according to this disclosure. FIG. 1A shows an exploded view of the system 100, and FIG. 1B shows an assembly view of the system 100. FIGS. 1A and 1B are described together below as FIG. 1. In this example, the system 100 is integrated into a single printed circuit board (PCB), although the system 100 may be integrated into any other suitable structures (such as a low-temperature co-fired ceramic (LTCC), etc.). In some cases, the system 100 can be referred to as circuit card assembly (CCA).

As shown in FIG. 1, the system 100 includes multiple layers of dielectric material, such as a superstrate radome 102 as a top layer, a middle layer 104, and a modeformer bottom layer 106. The system 100 also includes additional components 108 attached to the bottom surface of the bottom layer 106. The middle layer 104 includes a dielectric substrate 110, a spiral antenna 120 formed within a top surface of the dielectric substrate 110, at least one conductive feed via 130, a first planar grounding conductor 140, a second planar grounding conductor 142, a plurality of conductive first grounding vias 150, and a parasitic resistive film 160 beneath the spiral antenna 120. The top surface of the dielectric substrate 110 defines a first plane, the first planar grounding conductor 140 defines a second plane, and the second planar grounding conductor 142 defines a third plane such that the second plane is located between the first and second planes.

Multiple arms 122 form the spiral antenna 120. In this example, the spiral antenna 120 includes four arms 122. The spiral antenna 120 is composed of one or more conductive materials (such as one or more metals) and in some cases can be formed using one or more PCB or PWB techniques. Each conductive feed via 130 includes a first end 132 and a second end 134 opposite the first end 132. The first end 132 is electrically coupled to the spiral antenna 120 or other first device. In some cases, the at least one conductive feed via 130 includes multiple (such as four) conductive feed vias that are electrically coupled to respective arms 122, such as at the top surface of the substrate 110. In this example, the first end 132 of each feed via 130 has a shape that is the same shape as the beginning of the respective spiral arm 122. The body of each conductive feed via 130 may extend longitudinally through the entire thickness of the substrate 110 such that the second end 134 is located beyond the third plane.

The first planar grounding conductor 140 includes openings 144, which define areas without conductive material(s) and without any of the conductive first grounding vias 150. The first grounding vias 150 can be embedded within the dielectric substrate 110 and spaced apart from each other by a distance d0. For example, in some embodiments, the distance d0 is about 1/10 (such as ±10%) of a wavelength (λ) of waves that the spiral antenna 120 is configured to emit, where the wavelength can be a function of the diameter of the spiral antenna 120. As a particular example, the distance d0 may be about 1/10 of a wavelength at the highest frequency that the spiral antenna is configured to emit. The distance d0 can cause the plurality of first grounding vias 150 to collectively operate as if they are a solid grounding fence.

The parasitic resistive film 160 can be embedded within the dielectric substrate 110 beneath the antenna 120 and above the first planar grounding conductor 140 in the longitudinal direction. As a result, the parasitic resistive film 160 can overlap the first planar grounding conductor 140. In some cases, the parasitic resistive film 160 can be a printed resistor cavity termination. As described further below, the parasitic resistive film 160 may annularly surround a stepped cavity and, in some cases, may include an opening 162 that annularly surrounds an upper portion of a stepped cavity.

The radome 102 can be formed over the spiral antenna 120 to provide a protective cover for the spiral antenna 120. The radome 102 can be composed of at least one dielectric material, which may be deposited onto the middle layer 104 or may provide a surface onto which the middle layer 104 is formed (such as deposited). For example, the radome 102 can be composed of at least one material that is substantially or completely transparent to radio waves that the antenna 120 emits, which may be the same electrically-insulating material that forms non-conductive portions of a PCB or PWB. As a particular example, the radome 102 may be substantially or completely transparent to specific frequencies or frequency bands that the antenna 120 emits, and the radome 102 might attenuate other frequencies.

In this example, the bottom layer 106 includes or is coupled to a mode-former circuit 170, multiple planar grounding conductors 180, and a plurality of conductive second grounding vias 190. Note, however, that any other suitable second device may be formed on or coupled to the bottom layer 106. The multiple planar grounding conductors 180 are stacked on an opposite side of the second planar grounding conductor 142 relative to the conductive first grounding vias 150.

The mode-former circuit 170 is composed of at least one conductive material and can be formed using one or more PCB or PWB techniques. The mode-former circuit 170 can be configured to form simultaneous beams, such as a sum beam and a delta beam. In this example, the mode-former circuit 170 includes multiple electrodes configured to be electrically coupled to the second end 134 of the conductive feed vias 130. In some embodiments, each electrode of the mode-former circuit 170 has a shape that is the same shape as the second end 134 of the respective conductive fee via 130.

In some cases, at least some of the conductive second grounding vias 190 may be positioned to annularly surround the mode-former circuit 170. Others of the conductive second grounding vias 190 may be positioned within a perimeter of the mode-former circuit 170. The conductive second grounding vias 190 can be spaced apart from each other by a distance d3, which may cause the conductive second grounding vias 190 to collectively operate as if they are a solid grounding fence.

In some embodiments, the conductive second grounding vias 190 can be divided into different subsets that respectively form different layers of the second grounding vias 190. For example, different subsets of the conductive second grounding vias 190 may extend between the multiple planar grounding conductors 180 adjacent to each other or adjacent to the second planar grounding conductor 142. In this example, a first subset of second grounding vias 190 extends from the second planar grounding conductor 142 to the first planar grounding conductor 180a, a second subset of second grounding vias 190 extends between the first and second planar grounding conductors 180a-180b, a third subset of second grounding vias 190 extends between the second and third planar grounding conductors 180b-180c, and a fourth or N^{th} subset of second grounding vias 190 extends between the third planar grounding conductor 180c and a rear planar grounding conductor 180d (which is the fourth or N^{th} planar grounding conductor). Thus, in this example, the conductive second grounding vias 190 are located between the second planar grounding conductor 142 and the rear planar grounding conductor 180d.

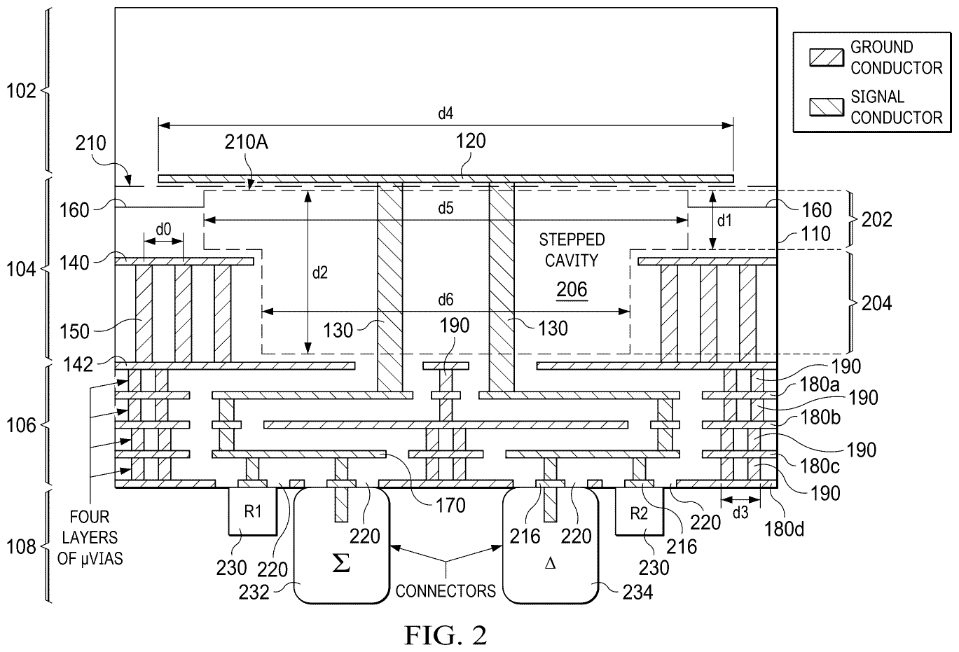

FIG. 2 illustrates a cross-sectional view of the example system 100 of FIG. 1 according to this disclosure. As shown in FIG. 2, within the middle layer 104, the dielectric substrate 110 includes a first portion 202 and a second portion 204 that form a stepped cavity 206.

The stepped cavity 206 enables the spiral antenna 120 to operate in multiple modes. For example, in a sum mode, the spiral antenna 120 radiates 1λ from a circumference of the spiral antenna 120. In a delta mode, the spiral antenna 120 radiates 2λ from a circumference of the spiral antenna 120. In this example, a diameter d4 of the spiral antenna 120 is approximately equal to 1λ. The combination of the spiral antenna 120, the stepped cavity 206, and the parasitic resistor termination (such as parasitic resistive film 160) enables the spiral antenna 120 to simultaneously emit a sum beam and a delta beam while absorbing sources of undesired interference at two depths d1 and d2. In some embodiments, the dielectric filling of the stepped cavity 206 may enable the stepped cavity 206 to have smaller dimensions compared to a traditional air-filled cavity. For example, the two depths d1 and d2 of the stepped cavity 206 may be shorter distances than two traditional air-filled cavities respectively associated with absorbing a sum beam and a delta beam from a spiral antenna having equal dimensions as the spiral antenna 120.

A top surface 210 of the dielectric substrate 110 within the middle layer 104 can be coplanar with a first planar surface 210a of the stepped cavity, which defines the first plane of the stepped cavity. The first portion 202 of the stepped cavity 206 spans a first diameter d5 and extends the first depth d1 from a first planar surface 210a to a second plane of the stepped cavity. The first planar grounding conductor 140 defines the second plane of the stepped cavity. The diameter d5 of the first portion 202 can be the same or substantially the same as the diameter of the opening 162 of the parasitic resistive film 160. In some embodiments, the diameter d4 of the spiral antenna 120 is greater than the diameter d5 of the first portion 202 and is less than the diameter of the top surface 210 of the dielectric substrate 110. The first planar surface 210a may represent a concentric portion of the top surface 210 of the dielectric substrate 110. The second portion 204 of the stepped cavity 206 spans a second diameter d6 and extends the second depth d2 from the first planar surface 210a to a third plane (defined by the second planar grounding conductor 142) of the stepped cavity 206 beyond the second plane. The second diameter d6 can be less than the first diameter d5.

The conductive feed vias 130 may extend through the stepped cavity 206. The first end of each conductive feed via 130 may be electrically coupled to and optionally integrated with the spiral antenna 120 or other first device. The first grounding vias 150 can annularly surround the second portion 204, thereby providing a vertical face whose length is d2−d1 (the difference between d2 and d1). In some cases, the first grounding vias 150 can be spaced apart by the distance d0, which can eliminate the need for a solid metal box that would have defined a traditional metal (such as aluminum) cavity housing with vertical walls (such as vertical faces).

The mode-former circuit 170 can include horizontal portions that are coplanar with the first, second, and third planar grounding conductors 180a-180c and can include signal conductors 216 (such as connection terminals) that may be coplanar with the rear planar grounding conductor 180d. For example, the rear planar grounding conductor 180d may include multiple openings 220 within which the dielectric substrate electrically isolates the rear planar grounding conductor 180d from the signal conductors 216. The additional components 108 in this example include at least two resistor terminations (R1 and R2) 230, a connector 232 associated with transmission of a sum beam, and another connector 234 associated with transmission of a delta beam. The connectors 232 and 234 can be configured to connect to the mode-former circuit 170 via the signal conductors 216 extending though the openings 220.

The parasitic resistive film 160 is configured to provide a parasitic resistive termination to terminate the spiral arms 122. In some embodiments, the parasitic resistive film 160 includes one or more surface mount device (SMD) resistors. The parasitic resistive film 160 may provide more effective multi-mode termination compared to traditional termination applied directly in contact with the antenna arms. Here, the parasitic resistive film 160 need not physically contact the spiral arms 122 at all.

Although FIGS. 1 and 2 illustrate one example of a system 100 in which a spiral antenna, a resistor cavity termination, a mode-former circuit, and a radome are integrated into a single structure, various changes can be made to FIGS. 1 and 2. For example, various components in FIGS. 1 and 2 could be combined, further subdivided, rearranged, duplicated, or omitted and additional components could be added according to particular needs. As a particular example, the middle layer 104 can represent a device onto which the antenna 120 and radome 102 are formed on one side and onto which the bottom layer 106 is formed on the opposite side. As another particular example, components like branch line couplers may be used to apply proper phasing to the spiral arms 122 of the spiral antenna 120. Also, while the system 100 is described as including a spiral antenna 120 and a mode-former circuit 170, these components may be respectively replaced by any other suitable first device and any other suitable second device. In addition, terms such as “top,” “bottom,” and “upper” are merely used with reference to the orientation of the system 100 shown here and do not require specific orientations of the system 100 during fabrication or use.

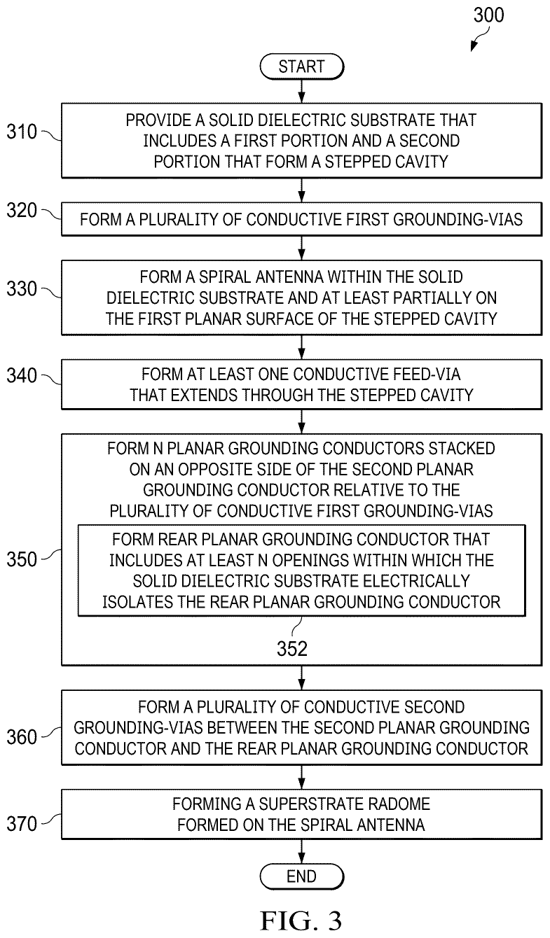

FIG. 3 illustrates an example method 300 of integrating a spiral antenna with a resistor cavity termination, a mode-former circuit, and a radome into a single structure according to this disclosure. For ease of explanation, the method 300 is described as being used to form the system 100 shown in FIGS. 1 and 2. However, the method 300 may be used to form any other suitable system having an antenna, a resistive cavity termination, a mode-former circuit, and a radome integrated into a single structure.

As shown in FIG. 3, at block 310, a dielectric substrate 110 that includes a first portion 202 and a second portion 204 forming a stepped cavity 206 is provided. The first portion 202 spans a first diameter d5 and extends a first depth d1 from a first planar surface 210a to a second plane of the stepped cavity 206. The first planar surface 210a defines a first plane of the stepped cavity 206. The second portion 204 spans a second diameter d6 less than the first diameter d5 and extends a second depth d2 from the first planar surface 210a to a third plane of the stepped cavity 206 beyond the second plane.

At block 320, multiple conductive first grounding vias 150 are formed. The conductive first grounding vias 150 are electrically coupled to a first planar grounding conductor 140 that defines the second plane and to a second planar grounding conductor 142 that defines the third plane and annularly surround the second portion 204. At block 330, a spiral antenna 120 or other first device is formed within the dielectric substrate 110 and at least partially on the first planar surface 210a of the stepped cavity 206. At block 340, at least one conductive feed via 130 that extends through the stepped cavity 206 is formed. A first end 132 of each conductive feed via 130 is electrically coupled to the spiral antenna 120 at the first planar surface 210a. A second end 134 of each conductive feed via 130 opposite the first end 132 is located beyond the third plane and is configured to electrically couple to a mode-former circuit 170 or other second device.

At block 350, multiple planar grounding conductors 180 stacked on an opposite side of the second planar grounding conductor 142 relative to the conductive first grounding vias 150 are formed. The multiple planar grounding conductors 180a-180d include a rear planar grounding conductor 180d that includes multiple openings 220 within which the dielectric substrate 110 electrically isolates the rear planar grounding conductor 180d from the signal conductors 216 (connection terminals) of the mode-former circuit 170 or other second device. As part of block 350, at block 352, the rear planar grounding conductor 180d is formed with the multiple openings 220.

At block 360, conductive second grounding vias 190 are formed between the second planar grounding conductor 142 and the rear planar grounding conductor 180d. At least some of the conductive second grounding vias 190 may be positioned to annularly surround the mode-former circuit 170 or other second device. Different subsets of the conductive second grounding vias 190 may extend between the multiple planar grounding conductors 180 adjacent to each other or adjacent to the second planar grounding conductor 142, thereby forming multiple layers of the second grounding vias. At block 370, a superstrate radome 102 is formed on or over the spiral antenna 120 or other first device.

Although FIG. 3 illustrates one example of a method 300 of integrating a spiral antenna with a resistor cavity termination, a mode-former circuit, and a radome into a single structure, various changes may be made to FIG. 3. For example, while shown as a series of steps, various steps in FIG. 3 could overlap, occur in parallel, occur in a different order, or occur any number of times.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A circuit card assembly (CCA) comprising:
a dielectric substrate having a first portion and a second portion that form a stepped cavity, the first portion spanning a first diameter and extending a first depth from a first planar surface defining a first plane to a second plane of the stepped cavity, the second portion spanning a second diameter less than the first diameter and extending a second depth from the first planar surface to a third plane of the stepped cavity beyond the second plane;
a plurality of conductive first grounding vias electrically coupled to a first planar grounding conductor that defines the second plane and to a second planar grounding conductor that defines the third plane and annularly surrounding the second portion; and
at least one conductive feed via that extends through the stepped cavity, the at least one conductive feed via comprising a first end configured to electrically couple to a first device at the first planar surface and a second end opposite the first end beyond the third plane configured to electrically couple to a second device.

2. The CCA of claim 1, wherein:
the first device comprises a spiral antenna; and
the second device comprises a mode-former circuit configured to form simultaneous beams including a sum beam and a delta beam.

3. The CCA of claim 1, further comprising:
a parasitic resistive film embedded within the dielectric substrate between the first plane and the second plane, overlapping the first planar grounding conductor, and annularly surrounding the stepped cavity.

4. The CCA of claim 1, wherein:
the first device comprises multiple arms that form a spiral antenna; and
the at least one conductive feed via includes multiple conductive feed vias respectively electrically coupled to the multiple arms.

5. The CCA of claim 1, wherein:
the first device comprises a spiral antenna; and
the conductive first grounding vias are embedded within the dielectric substrate and spaced apart from each other by a distance that is about 1/10 of a wavelength that the spiral antenna is configured to emit.

6. The CCA of claim 5, wherein the distance is about 1/10 of a wavelength at a highest frequency that the spiral antenna is configured to emit.

7. The CCA of claim 1, further comprising:
multiple planar grounding conductors stacked on an opposite side of the second planar grounding conductor relative to the conductive first grounding vias, the planar grounding conductors including a rear planar grounding conductor that includes multiple openings within which the dielectric substrate electrically isolates the rear planar grounding conductor from signal conductors of the second device.

8. The CCA of claim 7, further comprising:
a plurality of conductive second grounding vias between the second planar grounding conductor and the rear planar grounding conductor;
wherein at least some of the conductive second grounding vias are positioned to annularly surround the second device; and
wherein different subsets of the conductive second grounding vias extend between the planar grounding conductors adjacent to each other or adjacent to the second planar grounding conductor, thereby forming multiple layers of the second grounding vias.

9. A system comprising:
a dielectric substrate having a first portion and a second portion that form a stepped cavity, the first portion spanning a first diameter and extending a first depth from a first planar surface defining a first plane to a second plane of the stepped cavity, the second portion spanning a second diameter less than the first diameter and extending a second depth from the first planar surface to a third plane of the stepped cavity beyond the second plane;
a plurality of conductive first grounding vias electrically coupled to a first planar grounding conductor that defines the second plane and to a second planar grounding conductor that defines the third plane and annularly surrounding the second portion;
a spiral antenna within the dielectric substrate and at least partially on the first planar surface of the stepped cavity; and
at least one conductive feed via that extends through the stepped cavity, the at least one conductive feed via comprising a first end electrically coupled to the spiral antenna at the first planar surface and a second end opposite the first end beyond the third plane configured to electrically couple to a mode-former circuit.

10. The system of claim 9, further comprising the mode-former circuit, the mode-former circuit configured to form simultaneous beams including a sum beam and a delta beam.

11. The system of claim 9, further comprising:
a parasitic resistive film embedded within the dielectric substrate between the first plane and the second plane, overlapping the first planar grounding conductor, and annularly surrounding the stepped cavity.

12. The system of claim 9, wherein:
the spiral antenna comprises multiple arms; and
the at least one conductive feed via includes multiple conductive feed vias respectively electrically coupled to the multiple arms.

13. The system of claim 9, wherein the conductive first grounding vias are embedded within the dielectric substrate and spaced apart from each other by a distance that is about 1/10 of a wavelength that the spiral antenna is configured to emit.

14. The system of claim 13, wherein the distance is about 1/10 of a wavelength at a highest frequency that the spiral antenna is configured to emit.

15. The system of claim 9, further comprising:
multiple planar grounding conductors stacked on an opposite side of the second planar grounding conductor relative to the conductive first grounding vias, the planar grounding conductors including a rear planar grounding conductor that includes multiple openings within which the dielectric substrate electrically isolates the rear planar grounding conductor from signal conductors of the mode-former circuit.

16. The system of claim 15, further comprising:
a plurality of conductive second grounding vias between the second planar grounding conductor and the rear planar grounding conductor;
wherein at least some of the conductive second grounding vias are positioned to annularly surround the mode-former circuit; and
wherein different subsets of the conductive second grounding vias extend between the planar grounding conductors adjacent to each other or adjacent to the second planar grounding conductor, thereby forming multiple layers of the second grounding vias.

17. The system of claim 15, further comprising:
at least two resistor terminations; and
connectors configured to connect to the mode-former circuit via conductors extending though the openings.

18. The system of claim 9, further comprising a superstrate radome formed on the spiral antenna and configured to protect the spiral antenna.

19. A method comprising:
providing a dielectric substrate having a first portion and a second portion that form a stepped cavity, the first portion spanning a first diameter and extending a first depth from a first planar surface defining a first plane to a second plane of the stepped cavity, the second portion spanning a second diameter less than the first diameter and extending a second depth from the first planar surface to a third plane of the stepped cavity beyond the second plane;
forming a plurality of conductive first grounding vias electrically coupled to a first planar grounding conductor that defines the second plane and to a second planar grounding conductor that defines the third plane and annularly surrounding the second portion;
forming a spiral antenna within the dielectric substrate and at least partially on the first planar surface of the stepped cavity; and
forming at least one conductive feed via that extends through the stepped cavity, the at least one conductive feed via comprising a first end electrically coupled to the spiral antenna at the first planar surface and a second end opposite the first end beyond the third plane configured to electrically couple to a mode-former circuit.

20. The method of claim 19, further comprising:
forming multiple planar grounding conductors stacked on an opposite side of the second planar grounding conductor relative to the conductive first grounding vias, the planar grounding conductors including a rear planar grounding conductor that includes multiple openings within which the dielectric substrate electrically isolates the rear planar grounding conductor from signal conductors of the mode-former circuit; and
forming a plurality of conductive second grounding vias between the second planar grounding conductor and the rear planar grounding conductor;
wherein at least some of the conductive second grounding vias are positioned to annularly surround the mode-former circuit; and
wherein different subsets of the conductive second grounding vias extend between the planar grounding conductors adjacent to each other or adjacent to the second planar grounding conductor, thereby forming multiple layers of the second grounding vias.
